(19) United States
(12) Patent Application Publication
(10) Pub. No.: US 2026/0089621 A1
(43) Pub. Date: Mar. 26, 2026

(54) RU APPARATUS, DU APPARATUS, COMMUNICATION SYSTEM, AND COMMUNICATION METHOD

(71) Applicant: NEC CORPORATION, Minato-ku, Tokyo (JP)

(72) Inventor: Atsushi NAKATA, Tokyo (JP)

(73) Assignee: NEC CORPORATION, Minato-ku, Tokyo (JP)

(21) Appl. No.: 19/110,175

(22) PCT Filed: Aug. 23, 2023
(86) PCT No.: PCT/JP2023/030311

§ 371 Date: Mar. 10, 2025

(30) Foreign Application Priority Data
Sep. 22, 2022 (JP) 2022-151397

(51) Int. Cl. H04W 52/02

(52) U.S. Cl. CPC H04W 52/0206

(57) ABSTRACT

An object is to provide an RU apparatus capable of suppressing an increase in deterioration of communication quality related to communication of an O-RU. According to the present disclosure, a radio unit (RU) apparatus includes a reception unit that receives a message including an extended antenna-carrier identifier (eAxC ID) in a case where the RU apparatus operates in a first mode, and a transmission unit that transmits an alarm message indicating that an abnormality is detected, in a case where the eAxC ID is an eAxC ID that is not used in the first mode and is used in a second mode.

### TECHNICAL FIELD

The present disclosure relates to an RU apparatus, a DU apparatus, a communication system, and a communication method.

### BACKGROUND ART

In recent years, a radio access network has been used in which a baseband unit and a radio unit of a base station are separated and the baseband unit and the radio unit are connected via a front hole. The open-radio access network (O-RAN) fronthaul specification defined by the O-RAN Alliance defines the specification of a fronthaul between an O-RU (radio unit) corresponding to the radio unit, and an O-DU (distributed unit) and an O-CU (central unit) corresponding to the baseband unit. One object of the O-RAN fronthaul specification is to facilitate connection with an O-RU of a vendor different from a vendor of an O-DU, and to realize multi-vendor of a radio access network.

In the O-RAN fronthaul, specifications related to a control (C)-plane, a user (U)-plane, a synchronization (S)-plane, and an M-plane are defined. Here, Non Patent Literature 1 mainly defines specifications related to a management-plane (M-Plane) in an O-RAN fronthaul. An outline of functions related to the M-Plane disclosed in Non Patent Literature 1 will be described below.

The M-Plane provides a management function for the O-RU. Specifically, in the M-Plane, an O-DU or a network management system (NMS) is defined as a network device that manages an O-RU. Furthermore, in the M-Plane, a network configuration protocol (NETCONF), which is a protocol generally used in management of network devices, is defined. In NETCONF, a network device that manages an O-RU corresponds to a NETCONF client, and an O-RU as a management target corresponds to a netconf server.

Here, the M-Plane has a configuration management function. Specifically, the NETCONF client such as the O-DU retrieves, from the O-RU, the state of the apparatus, the functions on NETCONF with which the O-RU is compatible, and the like. Further, the NETCONF client sets a parameter to the O-RU. NETCONF defines edit-config for setting parameters and get-config for retrieving parameter values. The NETCONF client can modify the state of an apparatus (hardware) of the O-RU that can be set or changed, by using edit-config. Examples of the hardware state that can be set include a power state. By modifying the power state, it is possible to realize energy saving in the O-RU. Specifically, the NETCONF client causes the O-RU to transition to a state of awake or sleeping.

The state of awake is a state (normal mode) in which the O-RU performs a normal operation instead of an energy saving mode. On the other hand, the state of sleeping is a state in which the O-RU operates in the energy saving mode. In the state of sleeping, only the function related to the M-Plane can be operated, and the function related to the C/U/S-Plane can be stopped in order to suppress power consumption (see, for example, Section 9.1.3 of Non Patent Literature 1). For example, in the energy saving mode, the operation of some antennas among a plurality of antennas provided in the O-RU may be stopped.

In addition, Non Patent Literature 1 discloses that the NETCONF client assigns an extended antenna-carrier identifier (eAxC_ID). The eAxC ID is used for a C-Plane or U-Plane application to manage enhanced common public radio interface (eCPRI) communication between the O-DU and the O-RU in the C-Plane or the U-Plane. The eAxC_ID may be set to a different value for each antenna provided in the O-RU.

### CITATION LIST

### Non Patent Literature

Non Patent Literature 1: O-RAN-WG4.MP.0-v09.00 O-RAN Working Group 4 (Open Fronthaul Interfaces WG) Management Plane Specification

### SUMMARY OF INVENTION

### Technical Problem

In a case of performing eCPRI communication with the O-RU, the O-DU transmits, to the O-RU, a message in which the eAxC ID is set. At this time, in a case where the O-RU is operating in an energy saving mode, the O-DU may transmit, to the O-RU, a message in which the eAxC ID associated with the antenna whose operation is stopped is set. In such a case, since the message transmitted by the O-DU is not transmitted to a communication terminal or the like via the O-RU and is discarded in the O-RU, there is a problem that the communication quality related to the communication of the O-RU is deteriorated. Further, in a case where the O-DU continues to transmit, to the O-RU, a message in which the eAxC ID associated with the antenna whose operation is stopped is set, there is a problem that communication quality related to communication of the O-RU is further deteriorated.

In view of the above problem, an object of the present disclosure is to provide an RU apparatus, a DU apparatus, a communication system, and a communication method capable of suppressing an increase in deterioration of communication quality related to communication of an O-RU.

### Solution to Problem

According to a first aspect of the present disclosure, an RU apparatus includes a reception unit that receives a message including an extended antenna-carrier identifier (eAxC ID) in a case where the RU apparatus operates in a first mode, and a transmission unit that transmits an alarm message indicating that an abnormality has been detected, in a case where the eAxC ID is an eAxC ID that is not used in the first mode and is used in a second mode.

According to a second aspect of the present disclosure, a DU apparatus includes a transmission unit that transmits a message including an extended antenna-carrier identifier (eAxC ID) to an RU apparatus that operates in a first mode, a reception unit that receives, from the RU apparatus, an alarm message caused by the eAxC ID being an eAxC ID that is not used in the first mode and is used in the second mode, and a determination unit that determines to perform predetermined processing based on the alarm message.

According to a third aspect of the present disclosure, a communications system includes an RU apparatus, and a DU apparatus. The RU apparatus includes a reception unit that receives a message including an extended antenna-carrier identifier (eAxC ID) in a case where the RU apparatus operates in a first mode, and a transmission unit that transmits an alarm message indicating that an abnormality is detected, in a case where the eAxC ID is an eAxC ID that is not used in the first mode and is used in a second mode. The DU apparatus includes a transmission unit that transmits a message including an extended antenna-carrier identifier (eAxC ID) to the RU apparatus that operates in the first mode, a reception unit that receives, from the RU apparatus, an alarm message caused by the eAxC ID being an eAxC ID that is not used in the first mode and is used in the second mode, and a determination unit that determines to perform predetermined processing based on the alarm message.

According to a fourth aspect of the present disclosure, a communication method performed in an RU apparatus includes receiving a message including an extended antenna-carrier identifier (eAxC ID) in a case where the RU apparatus operates in a first mode, and transmitting an alarm message indicating that an abnormality is detected, in a case where the eAxC ID is an eAxC ID that is not used in the first mode and is used in a second mode.

According to a fifth aspect of the present disclosure, a communication method performed in a DU apparatus includes transmitting a message including an extended antenna-carrier identifier (eAxC ID) to an RU apparatus that operates in a first mode, receiving, from the RU apparatus, an alarm message caused by the eAxC ID being an eAxC ID that is not used in the first mode and is used in the second mode, and determining to perform predetermined processing based on the alarm message.

### Advantageous Effects of Invention

According to the present disclosure, it is possible to provide an RU apparatus, a DU apparatus, a communication system, and a communication method capable of suppressing an increase in deterioration of communication quality related to communication of an O-RU.

### BRIEF DESCRIPTION OF DRAWINGS

FIG. 1 is a configuration diagram of an RU apparatus according to the present disclosure.

FIG. 2 is a configuration diagram of a DU apparatus according to the present disclosure.

FIG. 3 is a diagram illustrating a flow of communication processing performed in the RU apparatus according to the present disclosure.

FIG. 4 is a diagram illustrating a flow of communication processing performed in the DU apparatus according to the present disclosure.

FIG. 5 is a configuration diagram of a communication system according to the present disclosure.

FIG. 6 is a diagram illustrating a flow of processing related to get-config included in NETCONF operations according to the present disclosure.

FIG. 7 is a diagram illustrating a data model generated by an O-DU according to the present disclosure.

FIG. 8 is a diagram illustrating a data model generated by the O-DU according to the present disclosure.

FIG. 9 is a diagram illustrating a data model generated by the O-DU according to the present disclosure.

FIG. 10 is a diagram illustrating a data model generated by the O-DU according to the present disclosure.

FIG. 11 is a diagram illustrating a flow of processing related to get-edit included in the NETCONF operations according to the present disclosure.

FIG. 12 is a diagram illustrating a flow of communication processing between the O-RU and the O-DU according to the present disclosure.

FIG. 13 is a diagram illustrating a flow of alarm message transmission processing in the O-RU according to the present disclosure.

FIG. 14 is a configuration diagram of a communication apparatus according to the present disclosure.

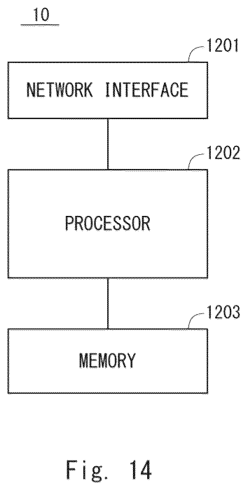

### EXAMPLE EMBODIMENT

### First Example Embodiment

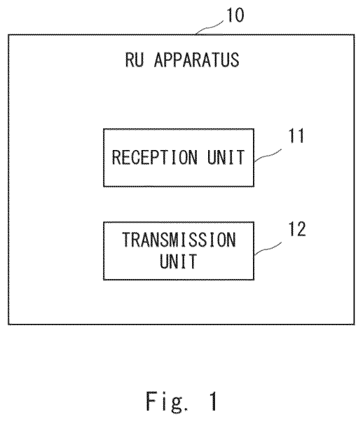

A configuration example of an RU apparatus 10 will be described below with reference to FIG. 1. The RU apparatus 10 may be a software component or module whose processing is carried out by causing the processor to execute the program stored in the memory. The RU apparatus 10 may be, for example, an O-RU node (referred to as an O-RU below) defined in the O-RAN Alliance. A node may correspond to an entity (apparatus) or may correspond to a function (function).

The RU apparatus 10 includes a reception unit 11 and a transmission unit 12. The reception unit 11 and the transmission unit 12 may be software components or modules whose processing is carried out by causing the processor to execute the program stored in the memory. Alternatively, the reception unit 11 and the transmission unit 12 may be hardware components such as circuits or chips.

The RU apparatus 10 operates in accordance with several operation modes. For example, the RU apparatus 10 operates in an energy saving mode or a normal mode. The RU apparatus 10 includes a plurality of antenna elements. For example, all antennas included in the RU apparatus 10 may operate in the normal mode, and at least one of a plurality of antennas included in the RU apparatus 10 may be stopped in the energy saving mode. Alternatively, among all the antenna elements included in the RU apparatus 10, an antenna element that operates in the normal mode and an antenna element that operates in the energy saving mode may be separated. The plurality of antenna elements may be arranged in an array. In other words, a plurality of antenna elements may constitute at least one antenna array.

The RU apparatus 10 has a radio communication interface, and is compatible with a wide bandwidth and enables more efficient communication, for example, by combining massive multiple input multiple output (Massive MIMO) and a digital beam forming technology. Massive MIMO makes it possible to direct different beams to each of a plurality of users, for example, by arranging a plurality of antenna elements at equal intervals on a plane (antenna array) and electrically controlling each antenna element. As a result, it is possible to simultaneously connect a large number of users to the O-RU.

The antenna array is constituted by several antenna elements associated to form a desired radiation pattern in the RU apparatus 10. By configuring a plurality of antenna arrays by the RU apparatus 10, it is possible to realize various radiation patterns for beams radiated from the RU apparatus 10.

In addition, an eAxC ID is set in each antenna element. Alternatively, the eAxC ID may be set for each antenna element group including two or more antenna elements. Setting may be paraphrased as being assigned or associated.

The reception unit 11 receives a message including the eAxC ID. The message including the eAxC ID is a message in which the eAxC ID is designated. The reception unit 11 may receive the message including the eAxC ID from the DU apparatus 15, for example. The DU apparatus 15 may be specifically an O-DU node (represented as an O-DU below). The message including the eAxC ID may be, for example, a message related to a C-Plane or a U-Plane. The message related to the C-Plane or the U-Plane may be paraphrased as a message transmitted via the C-Plane or the U-Plane.

Here, it is assumed that the RU apparatus 10 operates in the energy saving mode or the normal mode. The energy saving mode may be, for example, bringing the antenna element into a state of sleeping defined by the O-RAN Alliance. Alternatively, in the energy saving mode, a supply of power to some antenna elements among the plurality of antenna elements may be stopped, and all functions of some antenna elements may be stopped. On the other hand, an operation mode in which the antenna element performs a normal operation without stopping the functions of some antenna elements may be referred to as a normal mode. Alternatively, in the normal mode, a larger number of antenna elements than the number of antenna elements to be operated in the energy saving mode may be operated.

For example, in a case of operating in the energy saving mode, the RU apparatus 10 may receive a message including an eAxC ID set in an antenna element that does not operate in the energy saving mode. Alternatively, in a case of operating in the normal mode, the RU apparatus 10 may receive a message including an eAxC ID set in an antenna element that does not operate in the normal mode or an eAxC ID that is not used in the normal mode.

In such a case, the RU apparatus 10 transmits an alarm message indicating that an abnormality is detected. The alarm message may be paraphrased as an error message. The RU apparatus 10 may transmit the alarm message to the DU apparatus that is a transmission source of a message including an incorrect eAxC ID, or may transmit the alarm message to another DU apparatus. Alternatively, the RU apparatus 10 may transmit the alarm message to a management apparatus or a controller that manages the RU apparatus 10. The management apparatus or the controller that manages the RU apparatus 10 may be referred to as an O-RU controller. The O-RU controller may be a service management and orchestration (SMO) node (referred to as an SMO below). Alternatively, the O-RU controller may be an O-DU. The O-RU and the O-DU may be simply referred to as an RU and a DU.

However, the management apparatus or the controller that manages the RU apparatus 10 is not limited to the O-DU or the SMO. For example, the management apparatus or the controller may be any node as long as the node can communicate with the O-RU and is a node that performs a function of a NETCONF client.

Here, the alarm message may use common alarms in the O-RAN standard, for example. However, in this case, the alarm is preferably set with a dedicated ID (more specifically, Fault id). That is, the alarm may be set with a new Fault id that is not disclosed in Annex A of Non Patent Literature 1.

Note that the RU apparatus 10 may perform the following operation after transmitting the above alarm message. That is, after transmitting the above alarm message, the RU apparatus 10 may attempt recovery by autonomously resetting the RU apparatus 10 in a case where the alarm has not been canceled after a predetermined period. Details of this operation will be described in a second example embodiment. Alternatively, the RU apparatus 10 may increase Severity of the alarm and transmit the alarm message again.

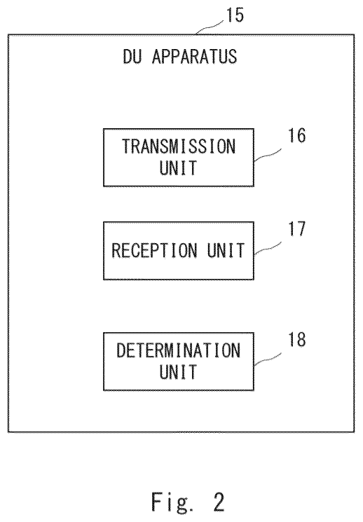

Next, a configuration example of the DU apparatus 15 will be described with reference to FIG. 2. The DU apparatus 15 may be a software component or module whose processing is carried out by causing the processor to execute the program stored in the memory. The DU apparatus 15 may be, for example, an O-DU node (referred to as an O-DU below) defined in the O-RAN Alliance.

The DU apparatus 15 includes a transmission unit 16, a reception unit 17, and a determination unit 18. The transmission unit 16, the reception unit 17, and the determination unit 18 may be software components or modules whose processing is carried out by causing the processor to execute the program stored in the memory. Alternatively, the transmission unit 16, the reception unit 17, and the determination unit 18 may be hardware such as a circuit or a chip.

The transmission unit 16 transmits a message including an eAxC ID to the RU apparatus 10 that operates in the energy saving mode or the normal mode. The reception unit 17 receives, from the RU apparatus 10, an alarm message caused by the eAxC ID being an eAxC ID that is not used in a mode in which the RU apparatus is currently operating but is used in the other mode.

The determination unit 18 determines predetermined processing based on the alarm message. Predetermined processing will be described below.

In a case where the reception unit 17 receives the alarm message, the determination unit 18 may determine to transmit the message including the correct eAxC ID to the RU apparatus 10 again. The correct eAxC ID may be determined based on, for example, an eAxC ID set as an eAxC ID that operates in the energy saving mode or an eAxC ID that operates in the normal mode, in a data model transmitted from the DU apparatus 15 to the RU apparatus 10. For example, in a case where the eAxC ID included in the message transmitted by the transmission unit 16 is an eAxC ID set in the antenna element that operates in the normal mode, it is assumed that the reception unit 17 receives the alarm message. In this case, the determination unit 18 may determine that the RU apparatus 10 operates in the energy saving mode, and determine that the eAxC ID set in the antenna element that operates in the energy saving mode is the correct eAxC ID. Alternatively, the alarm message received by the reception unit 17 may include information indicating the current operation mode in the RU apparatus 10, and may further include information indicating an antenna element that is currently operating in the RU apparatus 10. In this case, the determination unit 18 may specify the current operation mode in the RU apparatus 10, and determine that the eAxC ID set in the antenna element that operates in the current operation mode is the correct eAxC ID.

Alternatively, in a case where the reception unit 17 receives the alarm message, it may be determined that the message transmitted to the RU apparatus 10 is transmitted to an RU apparatus different from the RU apparatus 10. Alternatively, in a case where the reception unit 17 receives the alarm message, the determination unit 18 may determine to stop the operation of the RU apparatus 10. Alternatively, in a case where the reception unit 17 receives the alarm message, the determination unit 18 may determine to stop transmission of the message to the RU apparatus 10. Alternatively, in a case where an apparatus different from the DU apparatus 15 receives the alarm message, the apparatus that has received the alarm message may instruct the DU apparatus 15 to transmit a message including the correct eAxC ID. In this case, the DU apparatus 15 may determine to transmit the message including the correct eAxC ID. Alternatively, the apparatus that has received the alarm message may instruct a DU apparatus different from the DU apparatus 15 that has transmitted the message including the incorrect eAxC ID to transmit the message including the correct eAxC ID.

Alternatively, in a case where the reception unit 17 receives the alarm message, the determination unit 18 may determine to Deactivate the corresponding carrier (that is, the existing carrier).

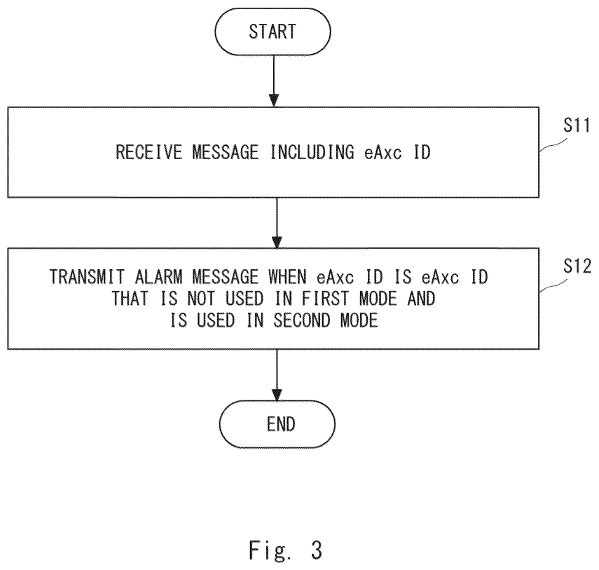

Next, a flow of communication processing in the RU apparatus 10 will be described with reference to FIG. 3. First, the reception unit 11 receives a message including an eAxC ID (S11). In a case of operating in the energy saving mode, the reception unit 11 receives a message including an eAxC ID set in an antenna element that does not operate in the energy saving mode. Alternatively, in a case of operating in the normal mode, the RU apparatus 10 receives a message including an eAxC ID set in an antenna element that does not operate in the normal mode. In this case, the transmission unit 12 transmits an alarm message indicating that an abnormality is detected (S12).

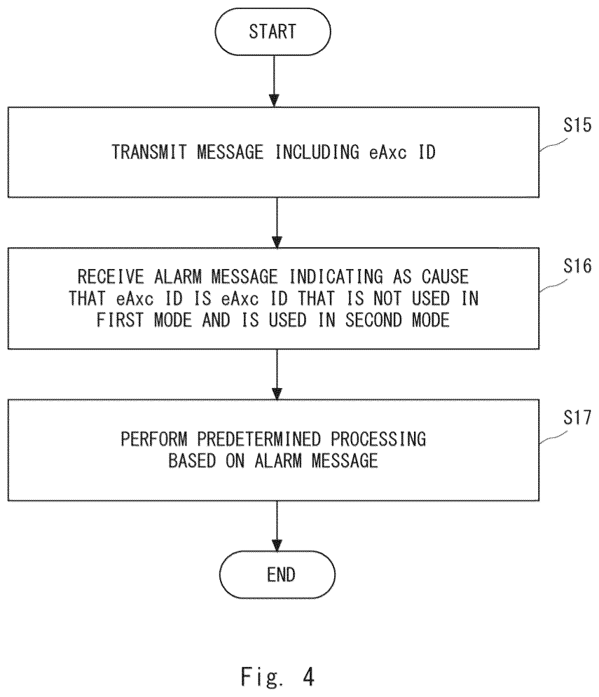

Next, a flow of communication processing in the DU apparatus 15 will be described with reference to FIG. 4. First, the transmission unit 16 transmits a message including the eAxC ID to the RU apparatus 10 that operates in the energy saving mode or the normal mode (S15). Then, the reception unit 17 receives, from the RU apparatus 10, an alarm message caused by the eAxC ID being an eAxC ID that is not used in the mode in which the RU apparatus 10 is currently operating but is used in the other mode (S16). Then, the determination unit 18 determines predetermined processing based on the alarm message (S17).

As described above, the RU apparatus 10 transmits an alarm message in a case of receiving a message including an eAxC ID set in an antenna element that is not used in the current operation mode. The apparatus that has received the alarm message operates so that a message including the correct eAxC ID is transmitted to the RU apparatus 10. Alternatively, the apparatus that has received the alarm message operates to stop transmission of the incorrect eAxC ID to the RU apparatus 10. As a result, since the RU apparatus 10 can receive the message including the correct eAxC ID or stop reception of the message including the incorrect eAxC ID, it is possible to suppress an increase in deterioration of communication quality caused by receiving the message including the incorrect eAxC ID.

### Second Example Embodiment

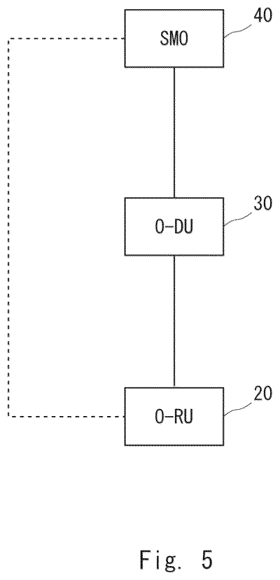

Next, a configuration example of a communication system will be described with reference to FIG. 5. The communication system of FIG. 3 illustrates an M-Plane architecture model defined in the O-RAN Alliance. The communication system of FIG. 5 includes an O-RU 20, an O-DU 30, and an SMO 40. The O-RU 20 corresponds to the RU apparatus 10 in FIG. 1. The O-DU 30 corresponds to the DU apparatus 15 in FIG. 2. In addition, the communication system may include an O-CU node and a near real-time RAN intelligent controller (Near-RT RIC) node (not illustrated). Furthermore, the SMO 40 may include a non real-time RAN intelligent controller (non-RT RIC) node (not illustrated). The O-CU may be simply referred to as a CU.

In addition, the O-RU 20 and the O-DU 30 may perform communication related to a C-Plane and a U-Plane. A virtual local area network (VLAN) different from a VLAN assigned to an M-Plane may be assigned to the C-Plane and the U-Plane. Assigning a VLAN may mean assigning a VLAN ID. The same VLAN may be assigned to each of the C-Plane and the U-Plane, or different VLANs may be assigned thereto.

The O-RU 20 is a logical node that performs a lower function (PHY-Low) of a physical layer and radio frequency (RF) processing. Alternatively, the O-RU 20 may be a physical device on which an O-RU that is a logical node is mounted. The lower function of the physical layer may be, for example, fast Fourier transform (FFT)/inverse FFT (IFFT) processing, beam forming (BF) processing, and the like.

The O-DU 30 is a logical node that executes functions in a packet data convergence protocol (PDCP) layer, a radio link control (RLC) layer, and a media access control (MAC) layer, and further executes upper functions of a physical layer. Alternatively, the O-DU 30 may be a physical device on which an O-DU that is a logical node is mounted. The higher function of the physical layer may be, for example, encoding and modulation processing, decoding and demodulation processing, and the like. The function in the PDCP layer may be executed in a logical node referred to as a central unit (CU) (not illustrated).

The SMO 40 performs maintenance and orchestration (control) of a radio access network (RAN) and a RAN intelligent controller (RIC) which is a platform for realizing optimization of radio resource management and automation of operation. Although FIG. 5 illustrates a configuration in which the O-RU 20 and the O-DU 30 are connected and the O-DU 30 and the SMO 40 are connected, the O-RU 20 and the SMO 40 may be connected as illustrated using a dotted line. In addition, although FIG. 5 illustrates a one-to-one configuration of the O-RU 20, the O-DU 30, and the SMO 40, the O-RU 20 may be managed by a plurality of O-DUs 30. Further, the O-RU 20 may be managed by a plurality of SMOs 40. In addition, the SMO 40 may be replaced with an NMS.

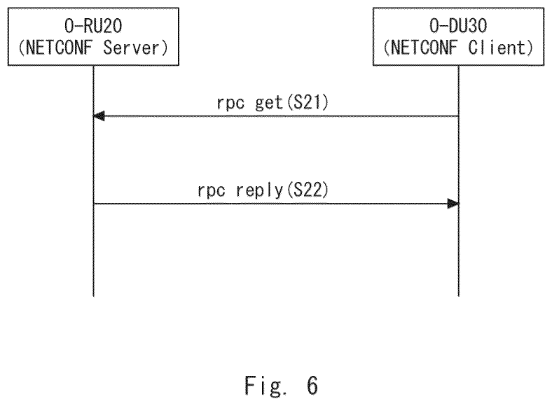

Next, a flow of processing related to get-config included in NETCONF operations performed in the Configuration Management function will be described with reference to FIG. 6. In FIG. 6, the O-RU 20 operates as a NETCONF Server, and the O-DU 30 operates as a NETCONF Client. First, the O-DU 30 transmits a request message to the O-RU 20 (S21). For example, rpc (remote procedure call) get may be configured in the request message. Then, the O-RU 20 transmits a reply message to the request message to the O-DU 30 (S22). For example, rpc-reply may be configured in the reply message. The reply message in which rpc-reply is configured includes a parameter retained by the O-RU 20 and the state of the O-RU 20, as data. That is, the O-DU 30 retrieves the parameter retained by the O-RU 20, the state of the O-RU 20, and the like from the O-RU 20 by executing the get procedure.

The parameter retained by the O-RU 20 may be indicated, for example, in the form of a data model (YANG data model) described using YANG. In addition, a YANG data model indicating a parameter or a state of the O-RU 20 that can be changed by the O-DU 30 may be defined as a YANG module. Specifically, a YANG data model indicating a parameter or a state used in the M-Plane may be defined as a reusable YANG module.

For example, the O-DU 30 fetches, receives, or retrieves a list of tx-arrays and rx-arrays in o-ran-uplane-conf. yang from the O-RU 20, and determines, specifies, or extracts tx-array elements and rx-array elements. tx-arrays indicates the entire antenna array used for transmission, and rx-arrays indicates the entire antenna array used for reception. o-ran-uplane-conf. yang indicates the YANG module defined in the O-RAN Alliance. tx-array elements and rx-array elements may be antenna arrays configured in the O-RU 20. tx-array elements is an antenna array related to transmission at the O-RU 20, and rx-array elements is an antenna array related to reception at the O-RU 20.

Further, the O-DU 30 fetches, receives, or retrieves a list of static-low-level-tx-endpoints and static-low-level-rx-endpoints in o-ran-uplane-conf. yang from the O-RU 20, and determines, specifies, or extracts static-low-level-tx-endpoint elements and static-low-level-rx-endpoint elements. The static-low-level-tx-endpoint elements are, for example, identification information of antenna elements related to transmission, and the static-low-level-rx-endpoint elements are, for example, identification information of antenna elements related to reception.

If the O-DU 30 determines the tx-array elements and the static-low-level-tx-endpoint element, the O-DU 30 examines the relationship between the tx-array elements and the static-low-level-tx-endpoint element. Further, if the O-DU 30 determines the rx-array elements and the static-low-level-rx-endpoint element, the O-DU 30 examines the relationship between the rx-array elements and the static-low-level-rx-endpoint element.

As a result of the examination, for example, the O-DU 30 may specify a static-low-level-tx-endpoint element indicating the antenna element constituting the tx-array element. Further, the O-DU 30 may specify a static-low-level-rx-endpoint element indicating an antenna element constituting the rx-array element.

Further, the O-DU 30 creates or generates a low-level-tx-endpoint element related to the static-low-level-tx-endpoint element, and creates or generates a low-level-rx-endpoint element related to the static-low-level-rx-endpoint element. The low-level-tx-endpoint element and the low-level-rx-endpoint element may be used, for example, to configure a desired parameter or state for the static-low-level-tx-endpoint element and the static-low-level-rx-endpoint element.

In addition, the O-DU 30 sets an extended antenna-carrier (eAxC) ID in the low-level-tx-endpoint element and the low-level-rx-endpoint. In a case of generating a plurality of low-level-tx-endpoint elements, the O-DU 30 sets an eAxC ID having a different value for each low-level-tx-endpoint element. Similarly, in a case of generating a plurality of low-level-rx-endpoint elements, the O-DU 30 sets an eAxC ID having a different value for each low-level-rx-endpoint element. The eAxC ID is a 16-bit value including DU_Port_ID, RU_Port_ID, CC_ID, and BandSector_ID. In addition, in a case where the eAxC ID set in the low-level-tx-endpoint element is used for the C-Plane and the U-Plane, the eAxC ID used for the C-Plane may be different from or the same as the eAxC ID used for the U-Plane. In a case where the eAxC ID set in the low-level-rx-endpoint is also used for the C-Plane and the U-Plane, the eAxC ID used for the C-Plane may be different from or the same as the eAxC ID used for the U-Plane.

Furthermore, the O-DU 30 generates a tx-array-carrier and an rx-array-carrier. The tx-array-carrier and the rx-array-carrier have “active” as a parameter, and any value of “ACTIVE”, “INACTIVE”, or “SLEEP” is set as the parameter “active”. The O-DU 30 generates a low-level-tx-links element and a low-level-rx-link element in order to associate the values of the parameter “active” set for the tx-array-carrier and the rx-array-carrier with the low-level-tx-endpoint element and the low-level-rx-endpoint element. That is, the O-DU 30 associates the value of the parameter “active” set for the tx-array-carrier and the rx-array-carrier with the low-level-tx-endpoint element and the low-level-rx-endpoint element via the low-level-tx-links element and the low-level-rx-link element. The associating may be paraphrased as, for example, applying, setting, or the like.

For example, in a case where “ACTIVE” is set to the parameter “active”, the antenna elements indicated by the static-low-level-tx-endpoint elements or the static-low-level-rx-endpoint elements may transition to the state of awake. In addition, in a case where “SLEEP” is set to the parameter “active”, the antenna elements indicated by the static-low-level-tx-endpoint elements or the static-low-level-rx-endpoint elements may transition to the state of sleeping. Furthermore, in a case where “INACTIVE” is set to the parameter “active”, all the functions of the antenna elements indicated by the static-low-level-tx-endpoint elements or the static-low-level-rx-endpoint elements may be stopped.

The O-DU 30 associates tx-array-carrier in which “SLEEP” is set to the parameter “active” with low-level-tx-endpoint elements associated with the antenna element to be transitioned to the state of sleeping. In addition, the O-DU 30 associates rx-array-carrier in which “SLEEP” is set to the parameter “active” with low-level-rx-endpoint elements associated with the antenna element to be transitioned to the state of sleeping.

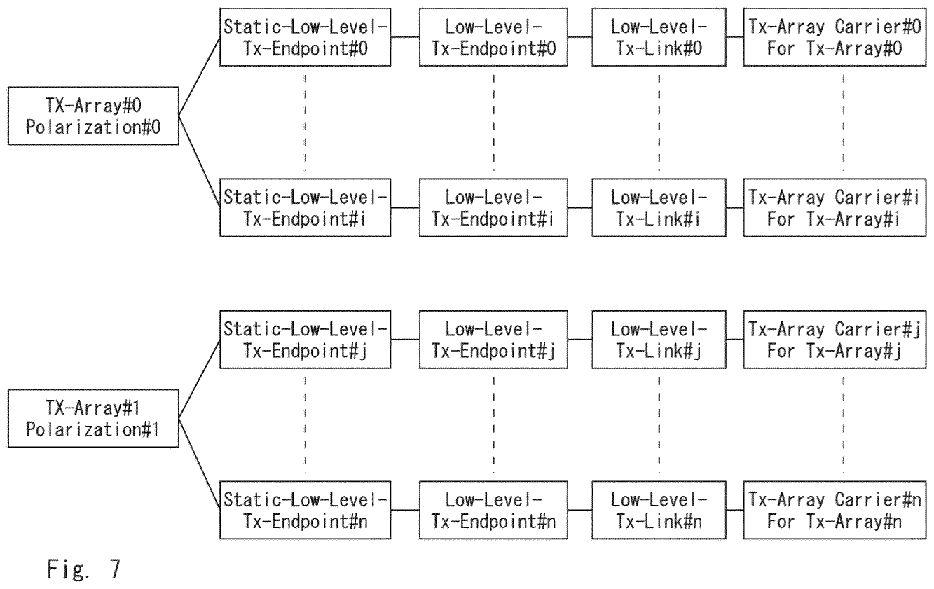

Here, a data model generated by the O-DU 30 based on the parameters retrieved from the O-RU 20 will be described with reference to FIGS. 7 to 10.

FIG. 7 illustrates an example of a data model related to the antenna array on the transmission side in the O-RU 20. The data model of FIG. 7 illustrates an example in which the antenna array on the transmission side in the O-RU 20 is configured by two antenna arrays of tx-array #0 and tx-array #1. The data model of FIG. 7 indicates that static-low-level-tx-endpoint #0 to static-low-level-tx-endpoint #i (i is an integer of 1 or more) constitute the tx-array #0. Furthermore, it is indicated that static-low-level-tx-endpoint #j to static-low-level-tx-endpoint #n (j and n are integers of 1 or more, and n>j=i+1) constitute the tx-array #1. In addition, the number of antenna elements constituting the tx-array #0 and the number of antenna elements constituting the tx-array #1 may be the same or different. The tx-array #0 and the tx-array #1 may be, for example, antenna arrays having different polarization planes.

In addition, a value set to the parameter “active” in the tx-array-carrier #0 is associated with low-level-tx-endpoint #0 indicating the setting of the static-low-level-tx-endpoint #0, through the low-level-tx-link #0. Similarly, in the other static-low-level-tx-endpoint, a value set to the parameter “active” in the tx-array-carrier #n is associated with low-level-tx-endpoint #n indicating the setting of the static-low-level-tx-endpoint #n, through the low-level-tx-link #n.

In the data model of FIG. 7, in a case where some antenna elements among the plurality of antenna elements included in the O-RU 20 are operated in the energy saving mode, the O-DU 30 causes the states of all the antenna elements constituting either the tx-array #0 or the tx-array #1 to transition to sleeping. For example, in a case of transitioning the states of all the antenna elements constituting the tx-array #0 to sleeping, the O-DU 30 sets the value of the parameter “active”in the tx-array-carrier #0 to #i to “SLEEP”.

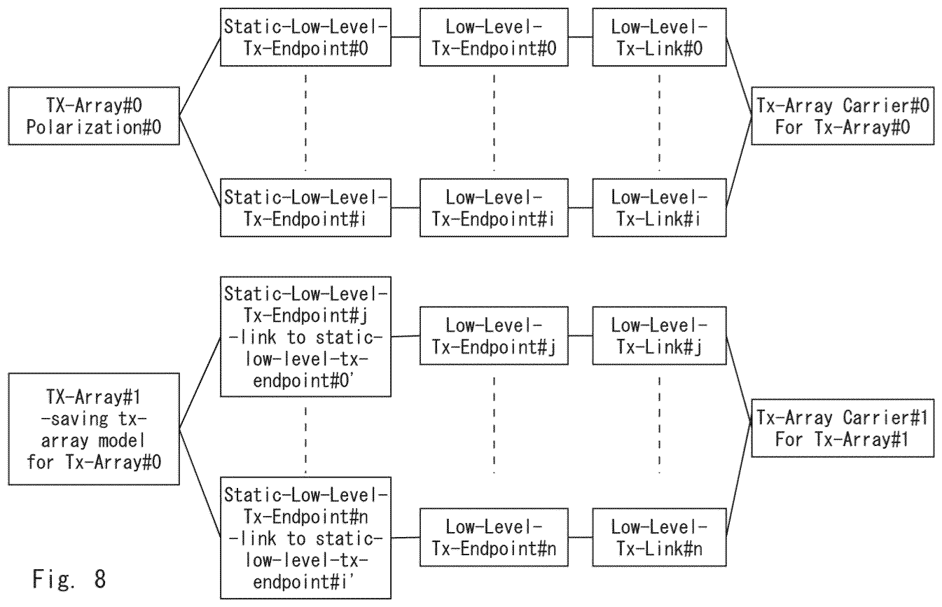

FIG. 8 illustrates still another example of the data model related to the antenna array on the transmission side in the O-RU 20. The data model of FIG. 8 illustrates an example in which the antenna array on the transmission side in the O-RU 20 is configured by one antenna array of tx-array #0. The data model of FIG. 8 indicates that static-low-level-tx-endpoint #0 to static-low-level-tx-endpoint #i (i is an integer of 1 or more) constitute the tx-array #0. Here, the tx-array #1 is defined as an antenna array configured by an antenna element that operates in the energy saving mode among antenna elements corresponding to the static-low-level-tx-endpoint #0 to the static-low-level-tx-endpoint #i. In other words, a second data model corresponding to the tx-array #1 may be additionally defined (that is, separately prepared) with respect to the first data model corresponding to the tx-array #0. Further, the second data model may be transmitted from the O-DU 30 to the O-RU 20 by a message. The message may be the above-described rpc message.

For example, the tx-array #1 is configured by the static-low-level-tx-endpoint #j to the static-low-level-tx-endpoint #n. Here, any one of static-low-level-tx-endpoint #0 to static-low-level-tx-endpoint #i is associated with each of the static-low-level-tx-endpoint #j to the static-low-level-tx-endpoint #n. #0′in “link to static-low-level-tx-endpoint #0′” illustrated in FIG. 8 indicates any of static-low-level-tx-endpoint #0 to static-low-level-tx-endpoint #i. Similarly, “link to static-low-level-tx-endpoint #i′ indicates any of static-low-level-tx-endpoint #0 to static-low-level-tx-endpoint #i. The static-low-level-tx-endpoint #j to the static-low-level-tx-endpoint #n may be referred to as a sub-set indicating the static-low-level-tx-endpoint included in the static-low-level-tx-endpoint #0 to the static-low-level-tx-endpoint #i.

The O-DU 30 may be notified, from O-RU 20, of the capability indicating that the static-low-level-tx-endpoints #j to #n associated as a sub-set of the static-low-level-tx-endpoints #0 to #i can be used to define the tx-array for the energy saving mode. For example, capabilities may be exchanged between the O-RU 20 and the O-DU 30 by using a hello message during a NETCONF session is established.

In addition, the data model of FIG. 8 illustrates that one tx-array-carrier is associated with each antenna array (tx-array). Specifically, the tx-array-carrier #O is associated with the low-level-tx-endpoint #0 to the low-level-tx-endpoint #i through the low-level-tx-link #0 to the low-level-tx-link #i. The tx-array-carrier #1 is associated with the low-level-tx-endpoint #j to the low-level-tx-endpoint #n through the low-level-tx-link #j to the low-level-tx-link #n. As described above, by associating the tx-array-carrier with each antenna array (tx-array), the states of all the antenna elements constituting one antenna array can be transitioned by the parameters set to one tx-array-carrier.

In the data model of FIG. 8, in a case of transitioning the O-RU 20 to the energy saving mode, the O-DU 30 may set the value of the parameter “active” to “ACTIVE” in the tx-array-carrier #0, and may set the value of “active” to “SLEEP” in the tx-array-carrier #1. As a result, among the antenna elements corresponding to the static-low-level-tx-endpoint #0 to the static-low-level-tx-endpoint #i, the states of the antenna elements associated with the static-low-level-tx-endpoint #j to the static-low-level-tx-endpoint #n can be transitioned to sleeping. Alternatively, the O-DU 30 may set the value of the parameter “active” to “SLEEP” in the tx-array-carrier #0, and further set the value of the parameter “active” to “ACTIVE” in the tx-array-carrier #1. As a result, among the antenna elements corresponding to the static-low-level-tx-endpoint #0 to the static-low-level-tx-endpoint #i, the states of the antenna elements which are not associated with the static-low-level-tx-endpoint #j to the static-low-level-tx-endpoint #n can be transitioned to sleeping.

In addition, the same eAxC ID and the same value as the low-level-tx-endpoints #0 to #i associated by “link to static-low-level-tx-endpoint” may be set to the eAxC ID set from the low-level-tx-endpoint #j to the low-level-tx-endpoint #n. For example, in a case where the static-low-level-tx-endpoint #j is associated with the static-low-level-tx-endpoint #0, the same eAxC ID as that of the low-level-tx-endpoint #0 may be set to the low-level-tx-endpoint #j. As a result, it is possible to reduce the number of eAxC IDs.

Alternatively, eAxC IDs having values different from those of the low-level-tx-endpoints #0 to #i may be set to the low-level-tx-endpoints #j to #n. For example, in a case where the static-low-level-tx-endpoint #j is associated with the static-low-level-tx-endpoint #0, different eAxC IDs are set to the low-level-tx-endpoint #j and the low-level-tx-endpoint #0. At this time, the O-DU 30 may determine which eAxC ID the static-low-level-tx-endpoint associated with is used for data transmission of the C-Plane and the U-Plane. For example, it is assumed that it is determined that the static-low-level-tx-endpoint associated with the eAxC ID set to the low-level-tx-endpoint #0 is used for data transmission of the C-Plane and the U-Plane. In this case, in the tx-array-carrier #0 and the tx-array-carrier #1, the static-low-level-tx-endpoint #j can be operated in the energy saving mode even in a case where the value of the parameter “active” is not set to “SLEEP”and is left to be “ACTIVE”.

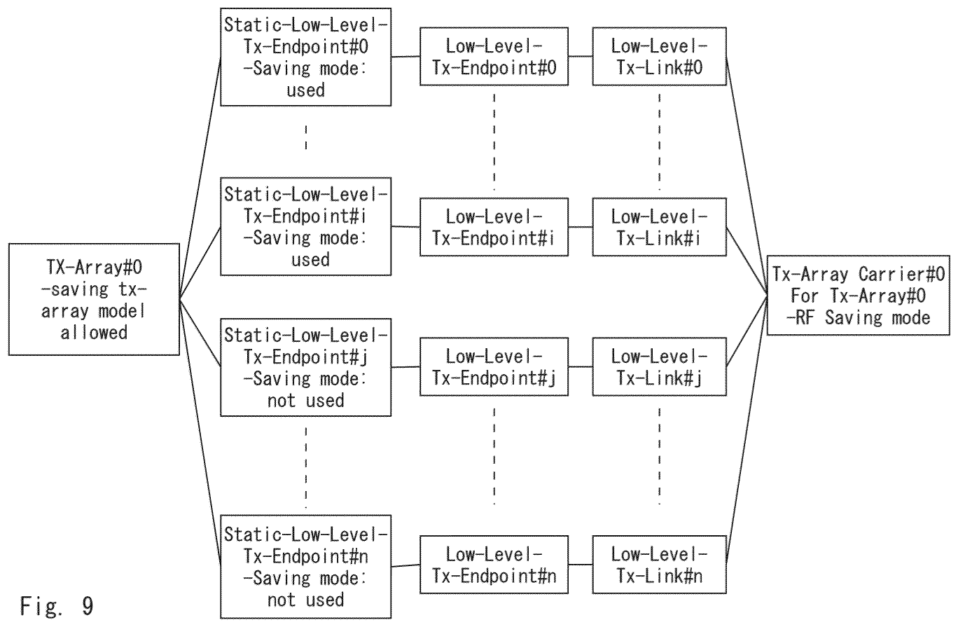

FIG. 9 illustrates still another example of the data model related to the antenna array on the transmission side in the O-RU 20. The data model of FIG. 9 illustrates an example in which the antenna array on the transmission side in the O-RU 20 is configured by one antenna array of tx-array #0. The data model of FIG. 9 indicates that static-low-level-tx-endpoint #0 to static-low-level-tx-endpoint #i (i is an integer of 1 or more) constitute the tx-array #0.

Furthermore, the parameter indicating whether or not the transition to sleeping can be performed in the energy saving mode is associated with the static-low-level-tx-endpoint #0 to the static-low-level-tx-endpoint #i. For example, the static-low-level-tx-endpoint in which the parameter “Saving mode: used” is set can transition to sleeping in the energy saving mode. On the other hand, the static-low-level-tx-endpoint in which the parameter of “Saving mode: not used” is set cannot transition to sleeping in the energy saving mode. In addition, the data model of FIG. 9 indicates that one tx-array-carrier #0 is associated with one tx-array #0 that is one antenna array.

In the data model of FIG. 9, in a case of transitioning the O-RU 20 to the energy saving mode, the O-DU 30 may set the value of the parameter “active” to “SLEEP” in the tx-array-carrier #0. At this time, the static-low-level-tx-endpoint in which the parameter of “Saving mode: not used” is set does not transition to sleeping even in a case where the value of the parameter “active” in the tx-array-carrier #0 is set to “SLEEP”. That is, in a case where the value of the parameter “active” in the tx-array-carrier #0 is set to “SLEEP”, only the static-low-level-tx-endpoint for which the parameter “Saving mode: used” is set transitions to sleeping. In other words, the data model set in the O-RU 20 is a single data model used in both the normal mode and the energy saving mode. Specifically, in a case where the O-RU 20 transitions to the energy saving mode, only the static-low-level-tx-endpoint in which the parameter “Saving mode: not used” in the data model is set is enabled even though the O-RU 20 is under the energy saving mode.

The O-DU 30 may be notified, from the O-RU 20, of the capability indicating that the parameter indicating whether or not the transition to sleeping can be performed in the energy saving mode can be associated with the static-low-level-tx-endpoint. For example, capabilities may be exchanged between the O-RU 20 and the O-DU 30 by using a hello message during a NETCONF session is established.

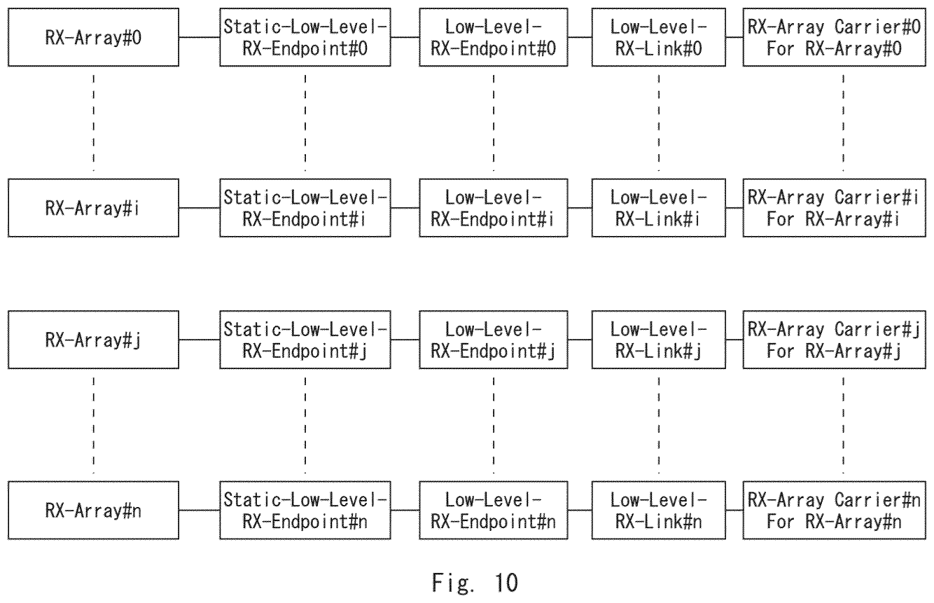

FIG. 10 illustrates a data model related to the antenna array on a reception side in the O-RU 20. The data model of FIG. 10 illustrates an example in which the antenna array on the transmission side in the O-RU 20 is configured by a plurality of antenna arrays of rx-array #0 to rx-array #n. The data model of FIG. 10 indicates that the static-low-level-rx-endpoint and the rx-array have a one-to-one correspondence.

In addition, the data model of FIG. 10 indicates that both the rx-array-carrier and the static-low-level-rx-endpoint have one-to-one correspondence.

In the data model of FIG. 10, in a case of transitioning the O-RU 20 to the energy saving mode, the O-DU 30 sets the value of the parameter “active” in the rx-array-carrier to “SLEEP” or “ACTIVE” for each antenna array. As a result, the O-DU 30 can transition to the energy saving mode for each antenna array.

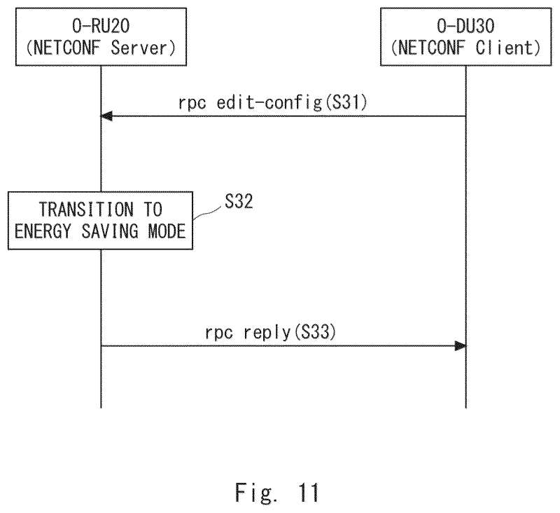

Next, a flow of processing related to edit-config included in NETCONF operations performed in the Configuration Management function will be described with reference to FIG. 11. As illustrated in FIGS. 7 to 10, the O-DU 30 updates the configuration information retrieved from the O-RU 20 to the data model indicating the antenna element to be transitioned to the energy saving mode. The O-DU 30 transmits a request message in which rpc edit-config is configured to the O-RU 20 (S31). The request message includes the data model updated in the O-DU 30.

Then, the O-RU 20 updates the state of each antenna element in accordance with the received data model (S32). The O-RU 20 transitions the state of each antenna element to the energy saving mode. For example, the O-RU 20 transitions the state of the antenna element associated with “SLEEP” to sleeping in the received data model.

Then, the O-RU 20 transmits a reply message in which rpc-reply is configured to the O-DU 30 (S33).

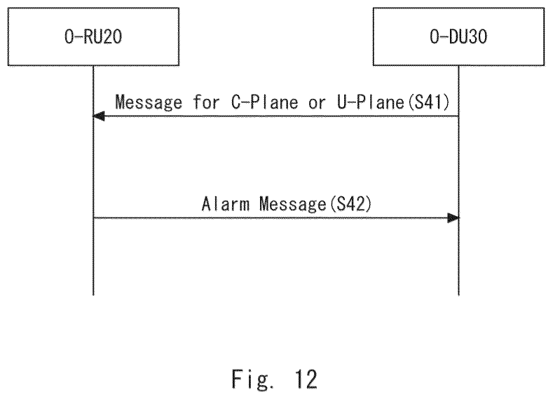

Next, a flow of a communication process between the O-RU 20 and the O-DU 30 will be described with reference to FIG. 12. Communication (C/U Plane transport) related to the C-Plane and the U-Plane between the O-RU 20 and the O-DU 30 may be performed on UDP/IP. Further, for communication (C/U Plane transport) related to the C-Plane and the U-Plane between the O-RU 20 and the O-DU 30, IPv4 and IPV6 may be used, and either of IPv4 and IPv6 may be used. In addition, an IP address used for communication related to the C-Plane and the U-Plane may be different from an IP address used for communication related to the M-Plane. The IP address used for communication related to the C-Plane may be the same as or different from the IP address used for communication related to the U-Plane.

First, the O-DU 30 transmits a message related to the C-Plane or the U-Plane to the O-RU 20 (S41). An eAxC ID is set in a message transmitted to the O-RU 20 by the O-DU 30. One eAxC ID or a plurality of eAxC IDs may be set in the message transmitted to the O-RU 20 by the O-DU 30. In addition, although FIG. 12 illustrates an example in which one message is transmitted from the O-DU 30 to the O-RU 20, a plurality of messages may be transmitted. In a case where a plurality of messages are transmitted from the O-DU 30 to the O-RU 20, eAxC IDs set in the respective messages may be different from each other, or a same eAxC ID may be set in some messages.

Then, in a case of receiving a message including an eAxC ID that is not used in the current operation mode, the O-RU 20 transmits an alarm message to the O-DU 30 (S42). In step S41, in a case of receiving a message related to the C-Plane, the O-RU 20 may transmit an alarm message related to the C-Plane to the O-DU 30. In step S41, in a case of receiving a message related to the U-Plane, the O-RU 20 may transmit an alarm message related to the U-Plane to the O-DU 30. Alternatively, in step S41, in a case of receiving the message related to the C-Plane or the U-Plane, the O-RU 20 may transmit the alarm message related to the M-Plane to the O-DU 30. In a case of receiving the alarm message, the O-DU 30 may transmit, to the O-RU 20, a message in which the eAxC ID used in the current operation mode in the O-RU 20 is set. Alternatively, the O-DU 30 may transfer the alarm message to the SMO 40 or transmit a message notifying an occurrence of an alarm to the SMO 40. Alternatively, in a case of receiving the alarm message, the O-DU 30 may update the parameter “active” in the tx-array-carrier and the rx-array-carrier to “INACTIVE” and transmit the updated data model to the O-RU 20.

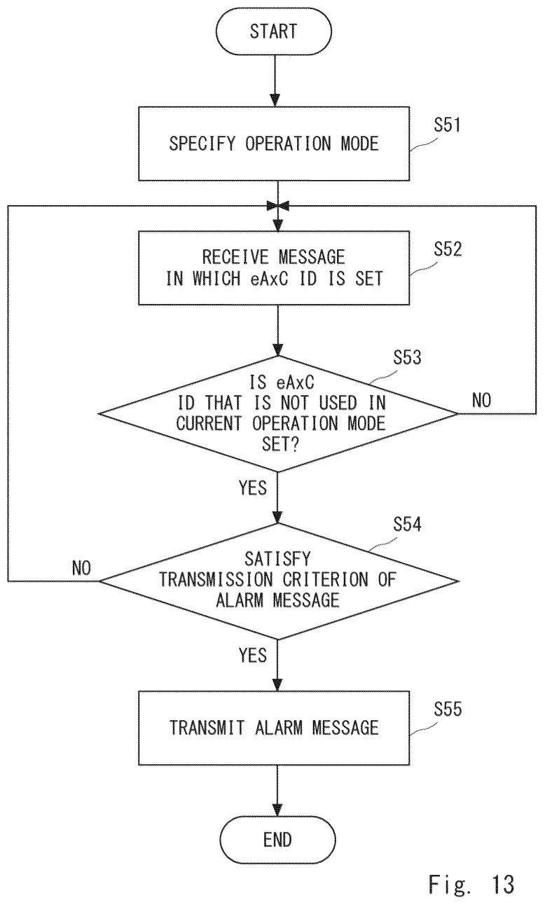

Next, a flow of alarm message transmission processing in the O-RU 20 will be described with reference to FIG. 13. First, a control unit (not illustrated) configured by a processor or the like of the O-RU 20 specifies the current operation mode (S51). Specifically, the control unit of the O-RU 20 specifies whether the O-RU 20 operates in the normal mode or the energy saving mode.

Then, the reception unit 11 of the O-RU 20 receives a message in which the eAxC ID is set (S52).

Then, the control unit of the O-RU 20 determines whether or not an eAxC ID that is not used in the current operation mode is set in the received message (S53). For example, a case where the O-RU 20 has the data model illustrated in FIG. 7 will be described. In the data model illustrated in FIG. 7, it is assumed that all the antenna elements constituting tx-array #0 and tx-array #1 operate in the normal mode, and the antenna elements constituting tx-array #0 operate in the energy saving mode. In such an assumption, in a case where the O-RU 20 operates in the energy saving mode, the control unit determines whether or not an eAxC ID different from the eAxC ID set in the antenna element that operates in the energy saving mode is set in the message. The eAxC ID different from the eAxC ID set in the antenna element that operates in the energy saving mode is an eAxC ID set in the antenna element that operates only in the normal mode.

In addition, in the data model illustrated in FIG. 7, it is assumed that the antenna element constituting tx-array #0 operates in the normal mode, and the antenna element constituting tx-array #1 operates in the energy saving mode. In such a case, for example, the control unit of the O-RU 20 that operates in the normal mode determines whether or not the eAxC IDs set in low-level-tx-endpoints #j to #n are set in the message. In addition, the control unit of the O-RU 20 that operates in the energy saving mode determines whether or not the eAxC IDs set in low-level-tx-endpoints #0 to #i are set in the message.

In addition, a case where the O-RU 20 has the data model illustrated in FIG. 8 will be described. In a case where the O-RU 20 operates in the energy saving mode, the control unit determines whether or not an eAxC ID different from the eAxC ID set in the antenna element that operates in the energy saving mode is set in the message.

Further, a case where the O-RU 20 has the data model illustrated in FIG. 8 and operates in the normal mode will be described. For example, eAxC IDs having values different from those of the low-level-tx-endpoints #0 to #i may be set to the low-level-tx-endpoints #j to #n. low-level-tx-endpoints #j to #n are used, for example, in a case where low-level-tx-endpoints #0 to #i associated with the low-level-tx-endpoints #j to #n are transitioned to the energy saving mode. In a case where the O-RU 20 operates in the normal mode, the control unit determines whether or not the eAxC IDs set in the low-level-tx-endpoints #j to #n are set in the message.

In addition, a case where the O-RU 20 has the data model illustrated in FIG. 9 will be described. In a case where the O-RU 20 having the data model illustrated in FIG. 9 operates in the energy saving mode, the control unit determines whether or not an eAxC ID different from the eAxC ID set in the antenna element that operates in the energy saving mode is set in the message.

In addition, a case where the O-RU 20 has the data model illustrated in FIG. 10 will be described. In the data model illustrated in FIG. 10, it is assumed that all antenna elements constituting rx-array #0 to #n operate in the normal mode, and antenna elements constituting rx-array #0 to #i operate in the energy saving mode. In such an assumption, in a case where the O-RU 20 operates in the energy saving mode, the control unit determines whether or not an eAxC ID different from the eAxC ID set in the antenna element that operates in the energy saving mode is set in the message. The eAxC ID different from the eAxC ID set in the antenna element that operates in the energy saving mode is an eAxC ID set in the antenna element that operates only in the normal mode.

In addition, in the data model illustrated in FIG. 10, it is assumed that antenna elements constituting rx-array #0 to #i operate in the normal mode, and antenna elements constituting rx-array #j to #n operate in the energy saving mode. In such a case, for example, the control unit of the O-RU 20 that operates in the normal mode determines whether or not the eAxC IDs set in low-level-rx-endpoints #j to #n are set in the message. In addition, the control unit of the O-RU 20 that operates in the energy saving mode determines whether or not the eAxC IDs set in low-level-rx-endpoints #0 to #i are set in the message.

Returning to FIG. 13, in a case where only the eAxC ID used in the current operation mode is set in the message, the control unit of the O-RU 20 repeats the processing of step S52 and the subsequent steps. In a case where an eAxC ID that is not used in the current operation mode is set in the message, the control unit of the O-RU 20 determines whether or not the transmission criterion of the alarm message is satisfied (S54). Here, the transmission criterion of the alarm message will be described.

The transmission criterion of the alarm message may be determined by using, for example, the number of messages including an eAxC ID that is not used in the current operation mode within a predetermined period. Specifically, the control unit may determine that the transmission criterion of the alarm message is satisfied in a case where the number of messages including the eAxC ID that is not used in the current operation mode within the predetermined period exceeds a threshold value, and the control unit may determine that the transmission criterion of the alarm message is not satisfied in a case where the number of messages does not exceed the threshold value. Alternatively, the control unit may determine that the transmission criterion of the alarm message is satisfied in a case where the number of eAxC IDs that are set in the message and are not used in the current operation mode exceeds a threshold value, and the control unit may determine that the transmission criterion of the alarm message is not satisfied in a case where the number of eAxC IDs that are set in the message and are not used in the current operation mode does not exceed the threshold value.

The predetermined period may be determined by, for example, a time such as 1 minute or 10 minutes. Alternatively, the predetermined period may be determined by the number of times of receiving messages transmitted from the O-DU 30, such as 5 times or 10 times.

Note that the value of the predetermined period may be set as a dedicated parameter (that is, a new parameter that is not disclosed in Non Patent Literature 1). In addition, the value of the predetermined period may be a fixed value (1 minute, 10 minutes, and the like) as described above, or may be a value different depending on implementation (that is, an implementation-dependent value). The same applies to the threshold value.

In a case of determining that the transmission criterion of the alarm is not satisfied, the control unit of the O-RU 20 repeats the processing of step S52 and the subsequent steps. In a case of determining that the transmission criterion of the alarm is satisfied, the control unit of the O-RU 20 transmits an alarm message (S55). After step S55, the processing of step S51 and the subsequent steps may be repeatedly performed.

The control unit of the O-RU 20 may include information indicating the current operation mode in the alarm message. Further, the control unit of the O-RU 20 may include information indicating the antenna element that operates in the current operation mode, in the alarm message. Alternatively, the control unit of the O-RU 20 may include information indicating the timing at which the current operation mode is switched, in the alarm message.

In addition, the control unit of the O-RU 20 may release the alarm state in a case where a message received from the O-DU 30 within a predetermined period after transmitting the alarm message no longer satisfies the transmission criterion of the alarm message. For example, the control unit of the O-RU 20 may transmit an alarm release message to the O-DU 30 in a case of releasing the alarm state. The criterion used to release the alarm state may be the same as the transmission criterion of the alarm message, or may be a criterion different from the transmission criterion of the alarm message. For example, a value larger or smaller than a threshold value used in the transmission criterion of the alarm message may be used as the criterion different from the transmission criterion of the alarm message. In a case where a state in which the transmission criterion of the alarm message is satisfied continues for a predetermined period, the control unit of the O-RU 20 may perform recovery processing such as resetting and restarting the O-RU 20.

As described above, the O-DU 30 can generate a data model for causing the state of the antenna element associated with the antenna array to transition to sleeping. The O-DU 30 can collectively transition the states of all the antenna elements associated with the antenna array to sleeping, or can transition the state to sleeping for each antenna element. In this manner, the O-DU 30 can efficiently transition the O-RU 20 to the energy saving mode by flexibly selecting the antenna element to be transitioned to the sleeping in the O-RU 20.

In addition, in a case of operating in the operation mode designated from the O-DU 30, the O-RU 20 transmits an alarm message in a case of receiving a message in which an eAxC ID that is not used in the current operation mode is set. As a result, the apparatus that has received the alarm message can take measures such as retransmitting the message in which the correct eAxC ID is set and changing a transmission path of the message. In addition, the O-RU 20 that has transmitted the alarm message can perform recovery processing such as resetting and restarting. As a result, it is possible to prevent an increase in the deterioration of the communication quality in the communication related to the O-RU 20.

FIG. 10 is a block diagram illustrating a configuration example of the RU apparatus 10 and the DU apparatus 15 (referred to as the RU apparatus 10 and the like). Referring to FIG. 10, the RU apparatus 10 and the like include a network interface 1201, a processor 1202, and a memory 1203. The network interface 1201 is used to communicate with a network node (e.g., eNB, MME, or P-GW). The network interface 1201 may include, for example, a network interface card (NIC) conforming to IEEE 802.3 series. Here, the eNB represents an evolved node B, the MME represents a mobility management entity, and the P-GW represents a packet data network gateway. IEEE represents Institute of Electrical and Electronics Engineers.

The processor 1202 executes the processing in the RU apparatus 10 and the like described using the flowcharts in the above-described example embodiments, by reading software (computer programs) from the memory 1203 and executing the software. The processor 1202 may be, for example, a microprocessor, a micro processing unit (MPU), or a central processing unit (CPU). The processor 1202 may include a plurality of processors.

The memory 1203 is constituted by a combination of a volatile memory and a nonvolatile memory. The memory 1203 may include a storage disposed away from the processor 1202. In this case, the processor 1202 may access the memory 1203 through an input/output (I/O) interface (not shown).

In the example of FIG. 10, the memory 1203 is used to store a software module group. The processor 1202 can execute the processing in the RU apparatus 10 and the like described in the above-described example embodiments by reading the group of software modules from the memory 1203 and executing the group of software modules.

As described with reference to FIG. 10, each of the processors included in the RU apparatus 10 and the like executes one or a plurality of programs including a command group causing a computer to perform the algorithm described with reference to the drawings.

Note that the RU apparatus 10 and the DU apparatus 15 respectively include similar network interfaces, processors, and memories. In addition, the RU apparatus 15 includes antennas for radio communication to UEs or other RU apparatuses. The antenna uses the antenna array (array antenna) as described above.

In the above-described example, the program may be stored using various types of non-transitory computer readable media and supplied to a computer. The non-transitory computer-readable media include various types of tangible storage media. Examples of the non-transitory computer-readable medium include a magnetic recording medium (for example, a flexible disk, a magnetic tape, or a hard disk drive), an optical magnetic recording medium (for example, a magneto-optical disk), a compact disc-read only memory (CD-ROM), a CD-R, a CD-R/W, and a semiconductor memory (for example, a mask ROM, a programmable ROM (PROM), an erasable PROM (EPROM), a flash ROM, or a random access memory (RAM). The program may be supplied to the computer by various types of transitory computer-readable media. Examples of the transitory computer-readable media include electrical signals, optical signals, and electromagnetic waves. The transitory computer-readable media can supply the programs to the computer via wired or wireless communication paths such as wires and optical fiber.

Note that the present disclosure is not limited to the above-described example embodiments, and can be appropriately modified without departing from the scope.

Some or all of the above-described example embodiments may be described as in the following Supplementary Notes, but are not limited to the following Supplementary Notes.

### Supplementary Note 1

A radio unit (RU) apparatus including:
a reception unit that receives a message including an extended antenna-carrier identifier (eAxC ID) in a case where the RU apparatus operates in a first mode; and
a transmission unit that transmits an alarm message indicating that an abnormality is detected, in a case where the eAxC ID is an eAxC ID that is not used in the first mode and is used in a second mode.

### Supplementary Note 2

The RU apparatus according to Supplementary Note 1, in which
the first mode is one of an energy saving mode and a normal mode, and
the second mode is a mode different from the first mode among the energy saving mode and the normal mode.

### Supplementary Note 3

The RU apparatus according to Supplementary Note 1 or 2, in which
the eAxC ID is set for each of a plurality of antenna elements included in the RU apparatus, and
the transmission unit
transmits the alarm message in a case where, in a case where the RU apparatus operates in the first mode, a message including an eAxC ID set in the antenna element that is not used in the first mode and is used in the second mode is received.

### Supplementary Note 4

The RU apparatus according to Supplementary Note 3, in which the transmission unit transmits the alarm message in a case where, in a case where the RU apparatus operates in the energy saving mode, and a message including an eAxC ID set in an antenna element that does not operate in the energy saving mode is received.

### Supplementary Note 5

The RU apparatus according to Supplementary Note 3 or 4, in which in a case where the plurality of antenna elements constitute a plurality of antenna arrays and a first antenna array included in the plurality of antenna arrays operates in the energy saving mode, the transmission unit transmits the alarm message in a case where the eAxC ID is an eAxC ID set in an antenna element constituting a second antenna array that does not operate in the energy saving mode and operates in the normal mode, the second antenna array being included in the plurality of antenna arrays.

### Supplementary Note 6

The RU apparatus according to Supplementary Note 3 or 4, in which in a case where the plurality of antenna elements constitutes one antenna array, a sub-antenna array including at least one antenna element that operates in the energy saving mode is defined among a plurality of antenna elements constituting the one antenna array, and the RU apparatus operates in the energy saving mode, the transmission unit transmits the alarm message in a case where the eAxC ID is an eAxC ID set in an antenna element that is not included in the sub-antenna array among the plurality of antenna elements.

### Supplementary Note 7

The RU apparatus according to any one of Supplementary Notes 1 to 6, in which the transmission unit transmits the alarm message in a case where the number of eAxC IDs that are not used in the first mode and are used in the second mode or the number of messages including the eAxC IDs that are not used in the first mode and are used in the second mode exceeds a threshold value within a predetermined period.

### Supplementary Note 8

The RU apparatus according to any one of Supplementary Notes 1 to 7, in which the reception unit receives a message transmitted via a C-Plane or a U-Plane.

### Supplementary Note 9

The RU apparatus according to any one of Supplementary Notes 1 to 8, in which the transmission unit transmits the alarm message via an M-Plane.

### Supplementary Note 10

A distributed unit (DU) apparatus including:
a transmission unit that transmits a message including an extended antenna-carrier identifier (eAxC ID) to an RU apparatus that operates in a first mode;
a reception unit that receives, from the RU apparatus, an alarm message caused by the eAxC ID being an eAxC ID that is not used in the first mode and is used in the second mode; and
a determination unit that determines to perform predetermined processing based on the alarm message.

### Supplementary Note 11

The DU apparatus according to Supplementary Note 10, in which the determination unit determines to transmit a message to the RU apparatus, the message indicating transition of the RU apparatus to a state of INACTIVE.

### Supplementary Note 12

The DU apparatus according to Supplementary Note 10, in which the determination unit determine to transmit a retransmission message to the RU apparatus, the retransmission message including an eAxC ID that is different from the eAxC ID included in the message.

### Supplementary Note 13

A communications system including:
an RU apparatus; and a DU apparatus, in which
the RU apparatus includes
a reception unit that receives a message including an extended antenna-carrier identifier (eAxC ID) in a case where the RU apparatus operates in a first mode, and
a transmission unit that transmits an alarm message indicating that an abnormality is detected, in a case where the eAxC ID is an eAxC ID that is not used in the first mode and is used in a second mode, and
the DU apparatus includes
a transmission unit that transmits a message including an extended antenna-carrier identifier (eAxC ID) to the RU apparatus that operates in the first mode,
a reception unit that receives, from the RU apparatus, an alarm message caused by the eAxC ID being an eAxC ID that is not used in the first mode and is used in the second mode, and
a determination unit that determines to perform predetermined processing based on the alarm message.

### Supplementary Note 14

The communication system according to Supplementary Note 13, in which
the first mode is one of an energy saving mode and a normal mode, and
the second mode is a mode different from the first mode among the energy saving mode and the normal mode.

### Supplementary Note 15

A communication method performed in a radio unit (RU) apparatus, the communication method including:
receiving a message including an extended antenna-carrier identifier (eAxC ID) in a case where the RU apparatus operates in a first mode; and
transmitting an alarm message indicating that an abnormality is detected, in a case where the eAxC ID is an eAxC ID that is not used in the first mode and is used in a second mode.

### Supplementary Note 16

The communication method according to Supplementary Note 15, in which
the first mode is one of an energy saving mode and a normal mode, and
the second mode is a mode different from the first mode among the energy saving mode and the normal mode.

### Supplementary Note 17

The communication method according to Supplementary Note 15 or 16, in which
the eAxC ID is set for each of a plurality of antenna elements included in the RU apparatus, and
in a case where the alarm message is transmitted,
the alarm message is transmitted in a case where, in a case where the RU apparatus operates in the first mode, a message including an eAxC ID set in the antenna element that is not used in the first mode and is used in the second mode is received.

### Supplementary Note 18

The communication method according to Supplementary Note 17, in which in a case where the alarm message is transmitted, the alarm message is transmitted in a case where, in a case where the RU apparatus operates in the energy saving mode, and a message including an eAxC ID set in an antenna element that does not operate in the energy saving mode is received.

### Supplementary Note 19

The communication method according to Supplementary Note 17 or 18, in which in a case where the plurality of antenna elements constitute a plurality of antenna arrays and a first antenna array included in the plurality of antenna arrays operates in the energy saving mode, in a case where the alarm message is transmitted, the alarm message is transmitted in a case where the eAxC ID is an eAxC ID set in an antenna element constituting a second antenna array that does not operate in the energy saving mode and operates in the normal mode, the second antenna array being included in the plurality of antenna arrays.

### Supplementary Note 20

The communication method according to Supplementary Note 17 or 18, in which in a case where the plurality of antenna elements constitutes one antenna array, a sub-antenna array including at least one antenna element that operates in the energy saving mode is defined among a plurality of antenna elements constituting the one antenna array, and the RU apparatus operates in the energy saving mode, in a case where the alarm message is transmitted, the alarm message is transmitted in a case where the eAxC ID is an eAxC ID set in an antenna element that is not included in the sub-antenna array among the plurality of antenna elements.

### Supplementary Note 21

The communication method according to any one of Supplementary Notes 15 to 20, in which in a case where the alarm message is transmitted, the alarm message is transmitted in a case where the number of eAxC IDs that are not used in the first mode and are used in the second mode or the number of messages including the eAxC IDs that are not used in the first mode and are used in the second mode exceeds a threshold value within a predetermined period.

### Supplementary Note 22

The communication method according to any one of Supplementary Notes 15 to 21, in which in a case where the message is transmitted, a message transmitted via the C-Plane or the U-Plane is received.

### Supplementary Note 23

The communication method according to any one of Supplementary Notes 15 to 22, in which in a case where the alarm message is transmitted, the alarm message is transmitted via the M-Plane.

### Supplementary Note 24

A communication method performed in a DU apparatus, the communication method including:
transmitting a message including an extended antenna-carrier identifier (eAxC ID) to an RU apparatus that operates in a first mode;
receiving, from the RU apparatus, an alarm message caused by the eAxC ID being an eAxC ID that is not used in the first mode and is used in the second mode; and
determining to perform predetermined processing based on the alarm message.

### Supplementary Note 25

The communication method according to Supplementary Note 24, in which in a case where the predetermined processing is performed, it is determined that a message indicating that the RU apparatus is transitioned to a state of INACTIVE is transmitted to the RU apparatus.

### Supplementary Note 26

The communication method according to Supplementary Note 24, in which in a case where the predetermined processing is performed, it is determined that a retransmission message including an eAxC ID that is different from the eAxC ID included in the message is transmitted to the RU apparatus.

### Supplementary Note 27

receiving a message including an extended antenna-carrier identifier (eAxC ID) in a case where the RU apparatus operates in a first mode; and
transmitting an alarm message indicating that an abnormality is detected, in a case where the eAxC ID is an eAxC ID that is not used in the first mode and is used in a second mode.

### Supplementary Note 28

The program according to Supplementary Note 27, in which
the first mode is one of an energy saving mode and a normal mode, and
the second mode is a mode different from the first mode among the energy saving mode and the normal mode.

### Supplementary Note 29

The program according to Supplementary Note 27 or 28, in which
the eAxC ID is set for each of a plurality of antenna elements included in the RU apparatus, and
in a case where the alarm message is transmitted,
the alarm message is transmitted in a case where, in a case where the RU apparatus operates in the first mode, a message including an eAxC ID set in the antenna element that is not used in the first mode and is used in the second mode is received.

### Supplementary Note 30

The program according to Supplementary Note 29, in which in a case where the alarm message is transmitted, the alarm message is transmitted in a case where, in a case where the RU apparatus operates in the energy saving mode, and a message including an eAxC ID set in an antenna element that does not operate in the energy saving mode is received.

### Supplementary Note 31

The program according to Supplementary Note 29 or 30, in which in a case where the plurality of antenna elements constitute a plurality of antenna arrays and a first antenna array included in the plurality of antenna arrays operates in the energy saving mode, in a case where the alarm message is transmitted, the alarm message is transmitted in a case where the eAxC ID is an eAxC ID set in an antenna element constituting a second antenna array that does not operate in the energy saving mode and operates in the normal mode, the second antenna array being included in the plurality of antenna arrays.

### Supplementary Note 32

The program according to Supplementary Note 29 or 30, in which in a case where the plurality of antenna elements constitutes one antenna array, a sub-antenna array including at least one antenna element that operates in the energy saving mode is defined among a plurality of antenna elements constituting the one antenna array, and the RU apparatus operates in the energy saving mode, in a case where the alarm message is transmitted, the alarm message is transmitted in a case where the eAxC ID is an eAxC ID set in an antenna element that is not included in the sub-antenna array among the plurality of antenna elements.

### Supplementary Note 33

The program according to any one of Supplementary Notes 27 to 32, in which in a case where the alarm message is transmitted, the alarm message is transmitted in a case where the number of eAxC IDs that are not used in the first mode and are used in the second mode or the number of messages including the eAxC IDs that are not used in the first mode and are used in the second mode exceeds a threshold value within a predetermined period.

### Supplementary Note 34

The program according to any one of Supplementary Notes 27 to 33, in which in a case where the alarm message is received, a message transmitted via a C-Plane or a U-Plane is received.

### Supplementary Note 35

The program according to any one of Supplementary Notes 27 to 34, in which in a case where the alarm message is transmitted, the alarm message is transmitted via an M-Plane.

### Supplementary Note 36

A program causing a computer to execute:
transmitting a message including an extended antenna-carrier identifier (eAxC ID) to an RU apparatus that operates in a first mode;
receiving, from the RU apparatus, an alarm message caused by the eAxC ID being an eAxC ID that is not used in the first mode and is used in the second mode; and
determining to perform predetermined processing based on the alarm message.

### Supplementary Note 37

The program according to Supplementary Note 36, in which in a case where the predetermined processing is performed, it is determined that a message indicating transition of the RU apparatus to a state of INACTIVE is transmitted to the RU apparatus.

### Supplementary Note 38

The program according to Supplementary Note 36, in which in a case where the predetermined processing is performed, it is determined that a retransmission message including an eAxC ID that is different from the eAxC ID included in the message is transmitted to the RU apparatus.

Although the present disclosure has been described with reference to the example embodiments, the present disclosure is not limited to the example embodiments described above. Various modifications that can be understood by those skilled in the art can be made to the configurations and details of the present disclosure within the scope of the present disclosure. Each example embodiment can be appropriately combined with another example embodiment.

Each drawing is merely illustrative for describing one or more example embodiments. Each drawing is not associated with only one specific example embodiment, but may be associated with one or more other example embodiments. As one of ordinary skill in the art will appreciate, various features or steps described with reference to any one of the drawings may be combined with features or steps shown in one or more other drawings, for example, to create an example embodiment not explicitly illustrated or described. All of the features or steps shown in any one of the drawings for describing example embodiments are not necessarily mandatory, and some features or steps may be omitted. The order of the steps described in any drawing may be changed as appropriate.

This application claims priority based on Japanese Patent Application No. 2022-151397 filed on Sep. 22, 2022, the entire disclosure of which is incorporated herein.

### REFERENCE SIGNS LIST

10 RU APPARATUS
11 RECEPTION UNIT
12 TRANSMISSION UNIT
15 DU APPARATUS
16 TRANSMISSION UNIT
17 RECEPTION UNIT
18 DETERMINATION UNIT
20 O-RU
30 O-DU
40 SMO

What is claimed is:

1. A radio unit (RU) apparatus comprising:
at least one memory storing instructions; and
at least one processor configured to execute the instructions to,
receive a message including an extended antenna-carrier identifier (eAxC ID) in a case where the RU apparatus operates in a first mode; and
transmit an alarm message indicating that an abnormality is detected, in a case where the eAxC ID is an eAxC ID that is not used in the first mode and is used in a second mode.

2. The RU apparatus according to claim 1, wherein
the first mode is one of an energy saving mode and a normal mode, and
the second mode is a mode different from the first mode among the energy saving mode and the normal mode.

3. The RU apparatus according to claim 1, wherein
the eAxC ID is set for each of a plurality of antenna elements included in the RU apparatus, and
the at least one processor is further configured to execute the instructions to
transmit the alarm message in a case where, in a case where the RU apparatus operates in the first mode, a message including an eAxC ID set in the antenna element that is not used in the first mode and is used in the second mode is received.

4. The RU apparatus according to claim 3, wherein the at least one processor is further configured to execute the instructions to transmit the alarm message in a case where, in a case where the RU apparatus operates in the energy saving mode, a message including an eAxC ID set in an antenna element that does not operate in the energy saving mode is received.

5. The RU apparatus according to claim 3, wherein in a case where the plurality of antenna elements constitute a plurality of antenna arrays and a first antenna array included in the plurality of antenna arrays operates in the energy saving mode, the at least one processor is further configured to execute the instructions to transmit the alarm message in a case where the eAxC ID is an eAxC ID set in an antenna element constituting a second antenna array that does not operate in the energy saving mode and operates in the normal mode, the second antenna array being included in the plurality of antenna arrays.

6. The RU apparatus according to claim 3, wherein in a case where the plurality of antenna elements constitutes one antenna array, a sub-antenna array including at least one antenna element that operates in the energy saving mode is defined among a plurality of antenna elements constituting the one antenna array, and the RU apparatus operates in the energy saving mode, the at least one processor is further configured to execute the instructions to transmit the alarm message in a case where the eAxC ID is an eAxC ID set in an antenna element that is not included in the sub-antenna array among the plurality of antenna elements.

7. The RU apparatus according to claim 1, wherein the at least one processor is further configured to execute the instructions to transmit the alarm message in a case where the number of eAxC IDs that are not used in the first mode and are used in the second mode or the number of messages including the eAxC IDs that are not used in the first mode and are used in the second mode exceeds a threshold value within a predetermined period.

8. The RU apparatus according to claim 1, wherein the at least one processor is further configured to execute the instructions to receive a message transmitted via a C-Plane or a U-Plane.

9. The RU apparatus according to claim 1, wherein the at least one processor is further configured to execute the instructions to transmit the alarm message via an M-Plane.

10. A communication method performed in a distributed unit (DU) apparatus, the communication method comprising:
transmitting a message including an extended antenna-carrier identifier (eAxC ID) to an RU apparatus that operates in a first mode;
receiving, from the RU apparatus, an alarm message caused by the eAxC ID being an eAxC ID that is not used in the first mode and is used in the second mode; and
determining to perform predetermined processing based on the alarm message.

11. The communication method according to claim 10, wherein transmitting a message to the RU apparatus is determined and the message indicates transition of the RU apparatus to a state of INACTIVE.

12. The communication method according to claim 10, wherein transmitting a retransmission message to the RU apparatus is determined and the retransmission message includes an eAxC ID that is different from the eAxC ID included in the message.

13. (canceled)

14. A communication method performed in a radio unit (RU) apparatus, the communication method comprising:
receiving a message including an extended antenna-carrier identifier (eAxC ID) in a case where the RU apparatus operates in a first mode; and
transmitting an alarm message indicating that an abnormality is detected, in a case where the eAxC ID is an eAxC ID that is not used in the first mode and is used in a second mode.

15. The communication method according to claim 14, wherein
the first mode is one of an energy saving mode and a normal mode, and
the second mode is a mode different from the first mode among the energy saving mode and the normal mode.

16. The communication method according to claim 14, wherein
the eAxC ID is set for each of a plurality of antenna elements included in the RU apparatus, and
in a case where the alarm message is transmitted,
the alarm message is transmitted in a case where, in a case where the RU apparatus operates in the first mode, a message including an eAxC ID set in the antenna element that is not used in the first mode and is used in the second mode is received.

17. The communication method according to claim 16, wherein in a case where the alarm message is transmitted, the alarm message is transmitted in a case where, in a case where the RU apparatus operates in the energy saving mode, and a message including an eAxC ID set in an antenna element that does not operate in the energy saving mode is received.

18. The communication method according to claim 16, wherein in a case where the plurality of antenna elements constitute a plurality of antenna arrays and a first antenna array included in the plurality of antenna arrays operates in the energy saving mode, in a case where the alarm message is transmitted, the alarm message is transmitted in a case where the eAxC ID is an eAxC ID set in an antenna element constituting a second antenna array that does not operate in the energy saving mode and operates in the normal mode, the second antenna array being included in the plurality of antenna arrays.

19. The communication method according to claim 16, wherein in a case where the plurality of antenna elements constitutes one antenna array, a sub-antenna array including at least one antenna element that operates in the energy saving mode is defined among a plurality of antenna elements constituting the one antenna array, and the RU apparatus operates in the energy saving mode, in a case where the alarm message is transmitted, the alarm message is transmitted in a case where the eAxC ID is an eAxC ID set in an antenna element that is not included in the sub-antenna array among the plurality of antenna elements.

20. The communication method according to claim 14, wherein in a case where the alarm message is transmitted, the alarm message is transmitted in a case where the number of eAxC IDs that are not used in the first mode and are used in the second mode or the number of messages including the eAxC IDs that are not used in the first mode and are used in the second mode exceeds a threshold value within a predetermined period.
